(19) United States
(12) Patent Application Publication
(10) Pub. No.: US 2024/0291024 A1
(43) Pub. Date: Aug. 29, 2024

(54) METHOD OF PRODUCING COMPOSITE SOLID ELECTROLYTE

(71) Applicant: KOREA INSTITUTE OF SCIENCE AND TECHNOLOGY, Seoul (KR)

(72) Inventors: Hun-Gi JUNG, Seoul (KR); Kyung Yoon Chung, Seoul (KR); Seungho Yu, Seoul (KR); Minah Lee, Seoul (KR); Jimin Shim, Seoul (KR); Jungjin Park, Seoul (KR); Hyeon-Ji Shin, Seoul (KR); Jun Tae Kim, Seoul (KR); A-Yeon Kim, Seoul (KR); Hyeon Seong Oh, Seoul (KR); Minyoung Lee, Seoul (KR); Hee-Dae Lim, Seoul (KR)

(21) Appl. No.: 18/417,456

(22) Filed: Jan. 19, 2024

(30) Foreign Application Priority Data
Feb. 13, 2023 (KR) 10-2023-0018734

(51) Int. Cl. H01M 10/0562

(52) U.S. Cl. CPC H01M 10/0562; H01M 2300/0068

(57) ABSTRACT

Provided is a method of producing a composite solid electrolyte. The method includes step S10 of producing an oxide-based solid electrolyte membrane by electrospinning a mixture including an oxide-based solid electrolyte precursor and a polymer, step S20 of producing an oxide-based solid electrolyte support by removing the polymer inside the oxide-based solid electrolyte membrane, and step S30 of causing the oxide-based solid electrolyte support to be impregnated with a sulfide-based solid electrolyte using a sulfide-based solid electrolyte precursor solution including a sulfide-based solid electrolyte precursor and a solvent.

### CROSS-REFERENCE TO RELATED APPLICATION

This application claims the benefit of Korean Patent Application No. 10-2023-0018734 filed on Feb. 13, 2023, in the Korean Intellectual Property Office, the entire disclosure of which is incorporated herein by reference for all purposes.

### BACKGROUND

### 1. Field of the Invention

One or more embodiments relate to a method of producing a composite solid electrolyte.

### 2. Description of the Related Art

A “battery” is a device that converts chemical energy into electrical energy, and as the demand for electric vehicles and large-capacity power storage devices increases, various batteries have been developed to satisfy the increased demand. “Secondary batteries” refer to batteries that, unlike primary batteries, may be recharged and used after being discharged. Among them, “lithium secondary batteries” produce electricity through a chemical reaction in which lithium ions move from a cathode to an anode when being discharged.

Lithium secondary batteries have the best energy density and output characteristics among various secondary batteries and have been widely commercialized. Lithium secondary batteries include a lithium secondary battery including a liquid-type electrolyte including an organic solvent (hereinafter, referred to as a “liquid-type secondary battery”) and a lithium secondary battery including a solid-type electrolyte (hereinafter, referred to as a “all-solid-state battery”).

The all-solid-state battery does not have problems such as expansion of a battery due to decomposition of a liquid electrolyte due to an electrode reaction or ignition due to leakage of a liquid electrolyte, and has advantages that a solid electrolyte acts as a separator to produce a battery in the form of a thin film without a separator of the related art, and the all-solid-state battery is thus attracting attention compared to the liquid-type secondary battery.

Examples of a solid electrolyte for the all-solid-state battery include a sulfide-based solid electrolyte and an oxide-based solid electrolyte, and a solid electrolyte has been mainly used in a mixed form with polymer materials.

A sulfide-based solid electrolyte has the advantage of a high ionic conductivity, but has a low mechanical rigidity and may not suppress lithium dendrite formation during a long-term operation.

An oxide-based solid electrolyte has the advantage of being easy to handle due to a low reactivity with the atmosphere and having superior mechanical properties compared to the sulfide-based solid electrolyte, but have the disadvantage of a low ionic conductivity.

Meanwhile, polymer materials have a low ionic conductivity and are unstable at high temperatures, causing a decrease in an ionic conductivity of a solid electrolyte membrane and making it vulnerable to heat generated during rapid charging.

Accordingly, in order to improve the performance of the all-solid-state battery, there is still a need to improve the solid electrolyte membrane.

### SUMMARY

In order to solve the aforementioned problems, embodiments provide a method of producing a composite solid electrolyte of an oxide-based solid electrolyte and a sulfide-based solid electrolyte that may exhibit performance at a high temperature without adding polymer materials and achieve synergy while reducing the disadvantages of the oxide-based solid electrolyte and the sulfide-based solid electrolyte.

However, goals obtainable from the present disclosure are not limited to the above-mentioned goal, and other unmentioned goals can be clearly understood from the following description by one of ordinary skill in the art to which the present disclosure pertains.

According to an aspect, there is provided a method of producing a composite solid electrolyte, the method including step S10 of producing an oxide-based solid electrolyte membrane by electrospinning a mixture including an oxide-based solid electrolyte precursor and a polymer, step S20 of producing an oxide-based solid electrolyte support by removing the polymer inside the oxide-based solid electrolyte membrane, and step S30 of causing the oxide-based solid electrolyte support to be impregnated with a sulfide-based solid electrolyte using a sulfide-based solid electrolyte precursor solution including a sulfide-based solid electrolyte precursor and a solvent, in which step S30 includes step S32 of immersing the oxide-based solid electrolyte support in a sulfide-based solid electrolyte precursor impregnation solution, and step S34 of drying the solvent, steps S32 and S34 are repeated two to six times, and step S30 further includes step S36 of adding the solvent to the sulfide-based solid electrolyte precursor solution before proceeding with the next steps S32 and S34 when repeating steps S32 and S34.

Additional aspects of example embodiments will be set forth in part in the description which follows and, in part, will be apparent from the description, or may be learned by practice of the disclosure.

When the method of producing the composite solid electrolyte of the present disclosure is used, it is possible to improve impregnation of the sulfide-based solid electrolyte, and it is advantageous to produce a solid electrolyte that is porous and has a thin film form with a large area, making it possible to mass-produce the composite solid electrolyte.

In addition, the composite solid electrolyte of the present disclosure has, not only excellent mechanical properties, but also an excellent ionic conductivity by removing polymers and minimizing voids, and is stable in a high temperature environment, enabling rapid charging of a secondary battery.

It should be understood that the effects of the present disclosure are not limited to the above-described effects, but are construed as including all effects that can be inferred from the configurations and features described in the following description or claims of the present disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a flowchart of a method of producing a composite solid electrolyte according to an embodiment of the present disclosure;

FIG. 2A is a diagram illustrating results of scanning electron microscopy (SEM) and energy-dispersive X-ray spectroscopy (EDS) of a composite solid electrolyte according to a comparative example of the present disclosure;

FIG. 2B is a diagram illustrating results of scanning electron microscopy (SEM) and energy-dispersive X-ray spectroscopy (EDS) of a composite solid electrolyte according to a production example of the present disclosure;

FIG. 3 is a diagram illustrating results of a resistance and an ionic conductivity of a composite solid electrolyte measured at room temperature according to an embodiment of the present disclosure; and

FIG. 4 is a diagram illustrating results of a resistance and an ionic conductivity of a composite solid electrolyte measured at 150° C. according to an embodiment of the present disclosure.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms.

A component, which has the same common function as a component included in any one embodiment, will be described by using the same name in other embodiments. Unless otherwise mentioned, the descriptions on the embodiments may be applicable to the following embodiments and thus, duplicated descriptions will be omitted for conciseness.

Throughout the present specification, when a portion “includes” a certain component, this does not mean that other components are excluded, but rather means that the portion may further include other components.

Unless otherwise specified, all numbers, values, and/or expressions used herein expressing quantities of components, reaction conditions, polymer compositions, and formulations are approximations reflecting various uncertainties of measurement inherently occurring when obtaining such values from others, and therefore, it should be understood that such numbers are used with the term “about” in all cases. In addition, when a numerical range is disclosed herein, such a range is continuous and, unless otherwise noted, includes all values from a minimum value to and including a maximum value of such a range. Furthermore, when such a range refers to an integer, all integers from a minimum value to and including a maximum value are included, unless otherwise noted.

Throughout the present specification, “electrospinning” is a method in which, when a high voltage is applied to an electrospinning solution including a polymer solution, a jet of the electrospinning solution is discharged from a tip and a solvent is volatilized, thereby obtaining a nanofiber having a nano-scaled diameter. When the electrospinning is used, a nanofiber sheet configured with nanofibers having a high specific surface area, porosity, a high aspect ratio, and flexibility may be manufactured, and nanofibers having different fiber diameters and the like may be easily manufactured by adjusting electrospinning conditions.

An electrospinning system for manufacturing a nanofiber sheet may be divided into an electrospinning solution supply unit, a high voltage supply unit, and a collector unit where nanofibers are formed. In addition, an electrospinning environment (humidity and temperature) needs to be maintained with predetermined optimal conditions. The electrospinning solution supply unit may be configured with a syringe pump and a syringe (or a nozzle) that accurately discharge a solution at a predetermined speed, and the characteristics of fibers may be controlled according to the design of a shape, diameter, and material of a syringe needle. The high voltage supply unit is an insulated cable consisting of a (+) pole that charges a polymer solution portion with a high dielectric constant and a (−) pole that collects the charged solution in the form of a nanofiber filament, and may control a voltage, a current, and the like. The collector unit where nanofibers are collected may adjust the arrangement of strands of a nanofiber according to the design of a shape, movement, a speed, or the like thereof, and materials having various shapes may also be manufactured depending on the purpose.

Meanwhile, an electrospinning solution used for the electrospinning generally needs to be well dissolved, and may greatly affect fiber formation according to the properties of the polymer solution used during the electrospinning. The properties of the solution include a concentration, viscosity, surface tension, conductivity, dielectric properties, volatility, and the like of the polymer solution. The concentration of the polymer solution is closely related to the viscosity, and the viscosity is known as an important factor that affects a shape, a diameter, a spraying speed of the fibers manufactured during the electrospinning, since it is a measure of a degree of entanglement and fluidity of polymer chains.

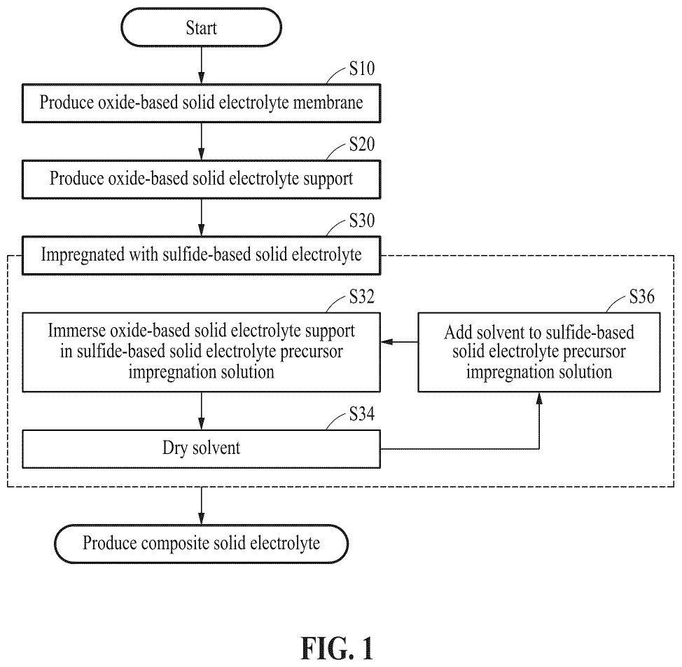

According to an embodiment of the present disclosure, a method of producing a composite solid electrolyte may be provided (FIG. 1). The method of producing the composite solid electrolyte may include step S10 of producing an oxide-based solid electrolyte membrane by electrospinning a mixed solution including an oxide-based solid electrolyte precursor and a polymer; step S20 of producing an oxide-based solid electrolyte support by removing the polymer inside the oxide-based solid electrolyte membrane; and step S30 of causing the oxide-based solid electrolyte support to be impregnated with a sulfide-based solid electrolyte using a sulfide-based solid electrolyte precursor solution including a sulfide-based solid electrolyte precursor and a solvent. Step S30 may include step S32 of immersing the oxide-based solid electrolyte support in a sulfide-based solid electrolyte precursor impregnation solution; and step S34 of drying the solvent, and steps S32 and S34 may be repeated two to six times. Step S30 may further include step S36 of adding the solvent to the sulfide-based solid electrolyte precursor solution before proceeding with the next steps S32 and S34 when repeating steps S32 and S34.

Step S10 is a step of producing an oxide-based solid electrolyte membrane. Specifically, step S10 may include step S12 of preparing an oxide-based solid electrolyte precursor solution, step S14 of preparing a polymer solution including the polymer, step S16 of producing the mixture by mixing the oxide-based solid electrolyte precursor solution with the polymer solution, and step S18 of producing the oxide-based solid electrolyte membrane by electrospinning the mixture.

Step S12 is a step of preparing a precursor mixture of precursors for producing the oxide-based solid electrolyte membrane and producing a solution.

The oxide-based solid electrolyte precursor may be a mixture of common precursors that may be used in the present disclosure, but is not limited to only a precursor mixture for producing a specific oxide-based solid electrolyte. In an example, it may be obtained by mixing at least one or more materials selected from the group consisting of a lithium (Li) precursor, a lanthanum (La) precursor, a zirconium (Zr) precursor, and an aluminum (Al) precursor, and is desirably a precursor mixture for producing a garnet-type and aluminum (Al)-doped oxide-based solid electrolyte (Al-LLZO (Li_{6.25}La₃Zr₂Al_{0.25}O₁₂)).

The lithium (Li) precursor may be, for example, at least one or more precursors selected from the group consisting of an acetate, nitrate, carbonate, chloride, hydroxide, and oxide containing lithium (Li) as a component. The lithium (Li) precursor may be desirably lithium nitrate (LiNO₃), lithium carbonate (Li₂CO₃), lithium oxide (Li₂O), lithium acetate dihydrate (LiCH₃COO·2H₂O), lithium hydroxide (LiOH), and the like.

The lanthanum (La) precursor may be, for example, at least one or more precursors selected from the group consisting of an acetate, nitrate, carbonate, chloride, hydroxide, and oxide containing lanthanum (La) as a component. The lanthanum (La) precursor may be desirably lanthanum (III) nitrate hexahydrate (La(NO₃)₃·6H₂O), lanthanum (III) oxide (La₂O₃), lanthanum hydroxide (La(OH)₃), lanthanum(III) acetate sesquihydrate (La(CH₃COO)₃·1.5H₂O), and the like.

The zirconium (Zr) precursor may be, for example, at least one or more precursors selected from the group consisting of an acetate, nitrate, carbonate, chloride, hydroxide, and oxide containing zirconium (Zr) as a component. The zirconium (Zr) precursor may be desirably zirconium (IV) oxynitrate hydrate (ZrO(NO₃)₂·xH₂O), zirconium dioxide (ZrO₂), zirconium propoxide (Zr(OCH₂CH₂CH₃)₄), zirconium (IV) oxychloride octahydrate (ZrOCl₂·8H₂O), and the like.

The aluminum (Al) precursor may be, for example, at least one or more precursors selected from the group consisting of an acetate, nitrate, carbonate, chloride, hydroxide, and oxide containing aluminum (Al) as a component. The aluminum (Al) precursor may be desirably aluminum nitrate nonahydrate (Al(NO₃)₃·9H₂O), aluminum oxide (Al₂O₃), and the like.

In this case, the solvent mixed with the oxide-based solid electrolyte precursor may be a solvent capable of dissolving the precursor. For example, it may include at least one or more solvents selected from the group consisting of dimethylformamide (DMF) and acetic acid, and is not limited to including only a specific solvent.

A concentration of the oxide-based solid electrolyte precursor solution may be 3.4 M to 3.42 M. If the concentration of the precursor solution is lower than 3.4 M, there is a problem that a solid electrolyte membrane is not formed after heat treatment. On the other hand, if the concentration of the precursor solution is higher than 3.42 M, the viscosity of the solution is high, making the electrospinning difficult.

Step S14 is a step of preparing a polymer solution. The polymer included in the polymer solution may be mixed with the precursor solution so that the electrospinning may be easily performed.

For example, the polymer may include at least one or more selected from the group consisting of polyvinyl pyrrolidine (PVP), polyvinyl alcohol (PVA), and polyvinyl acetate (PVAc), and is not limited to including only a specific polymer.

The solvent mixed with the polymer may be a solvent that may completely dissolve the polymer, and is not limited to including only a specific component. For example, it may include at least one or more selected from the group consisting of DMF and acetic acid.

A concentration of the polymer solution may be 0.099 mM to 0.1 mM. If the concentration of the polymer solution is lower than 0.099 mM, nanofibers are not formed, and if the concentration of the polymer solution exceeds 0.1 mM, the viscosity of the solution is high, making the electrospinning difficult.

Step S16 is a step of producing a homogeneous mixture by mixing the prepared precursor solution and polymer solution with each other. By performing the electrospinning using the mixture of precursors and polymers uniformly dissolved, a solid electrolyte membrane having uniform nanofibers may be obtained.

A content of the precursor solution in the mixed solution may be 57% by weight to 58% by weight, and desirably 57.9% by weight to 58% by weight with respect to a total weight of the mixed solution. If the content of the precursor solution is less than 57% by weight, the solid electrolyte membrane may not be formed after heat treatment, and if the content of the precursor solution is more than 58% by weight, the viscosity of the solution is high, making the electrospinning difficult.

The content of the polymer solution in the mixed solution may be 42% by weight to 43% by weight, and desirably 42% by weight to 42.1% by weight with respect to the total weight of the mixed solution. If the content of the polymer solution is less than 42% by weight, nanofibers may not be formed, and if the content of the polymer solution is more than 43% by weight, the viscosity of the solution is high, making the electrospinning difficult.

The precursor and polymer mixture may be stirred using a stirrer at a temperature of 40° C. to 50° C. and a speed of 400 rpm to 600 rpm for 2 to 3 hours. Through this, a homogeneous mixed solution without bubbles may be obtained. Even after this process, a known bubble remove process may be additionally performed, because it is difficult to obtain homogeneous fibers during the electrospinning if the mixed solution includes bubbles. At this time, a known defoaming process may be performed to remove bubbles.

Step S18 is a step of producing the oxide-based solid electrolyte membrane using the produced mixed solution. In this step, an oxide-based solid electrolyte membrane having nanofibers, a plate-shaped material having a large area, may be produced through the electrospinning.

The electrospinning may be performed under the conditions of a voltage of 8.5 to 10.5 kV, a discharge speed of the mixed solution of 0.6 milliliters per hour (ml/hr) to 0.8 ml/hr, and an electrospinning distance of 10 to 12 centimeters (cm). If the voltage is beyond the above range and is too low, the nanofibers may not be formed and the mixed solution falls as beads, and if the voltage is too high, the electrospinning is performed in the form of spray rather than in the form of nanofibers. In addition, if the discharge speed is too slow, the time of the electrospinning may be long, and if the discharge speed is too fast, it is difficult to form the nanofibers and a thickness of the nanofiber may increase.

Step S18 may desirably further include step of drying the oxide-based solid electrolyte membrane to completely remove the solvent remaining in the oxide-based solid electrolyte membrane. The step of drying may be performed at a temperature of 140° C. to 160° C. for 4 to 10 hours. If the drying temperature is less than 140° C. or the drying time is less than 4 hours, the oxide-based solid electrolyte membrane may be damaged by a residual solvent that has not evaporated in step S20.

Step S20 is a calcination step, that is, a step of carbonizing and removing the polymer inside the oxide-based solid electrolyte membrane, through which the oxide-based solid electrolyte support may be obtained.

In step S20, the temperature of the electrospinning system may be increased to a calcination temperature of 400° C. to 700° C. at a temperature increase rate of 1° C./min to 2° C./min, and the dried oxide-based solid electrolyte membrane may be heated at the calcination temperature for 2 to 3 hours. In a case of the oxide-based solid electrolyte, Al-LLZO (Li₇La₃Zr₂O₁₂), when the temperature increases to 700° C., an oxide-based solid electrolyte having a cubic shape may be formed due to the combination of precursors, in addition to the carbonization of the polymer. If the temperature increase rate is less than 1° C./min, the time required to reach the calcination temperature becomes longer and the process cost may increase, and if the temperature increase rate exceeds 2° C./min, the temperature may easily fall out of range of the calcination temperature. On the other hand, if the calcination temperature is lower than 400° C., the polymer may not be removed smoothly, and if the calcination temperature is higher than 700° C., the decomposition of the polymer and the formation of the oxide may proceed simultaneously, and the oxide-based solid electrolyte membrane may be damaged. If a calcination time is less than 2 hours, the polymer may not be removed smoothly, and if the calcination time exceeds 3 hours, the time required for the calcination may become longer and the process cost may increase.

Step S30 is a step of immersing the produced oxide-based solid electrolyte support in a sulfide-based solid electrolyte precursor solution, through which a composite solid electrolyte in which the oxide-based solid electrolyte is impregnated with the sulfide-based solid electrolyte may be produced, and the composite solid electrolyte maintaining each crystal structure without a significant reaction between the oxide-based solid electrolyte and the sulfide-based solid electrolyte may be produced.

Specifically, step S30 may include step S32 of immersing the oxide-based solid electrolyte support in the sulfide-based solid electrolyte precursor impregnation solution; and step S34 of drying the solvent.

In step S32, a concentration of the sulfide-based solid electrolyte precursor impregnation solution may be 0.01 M to 0.35 M. If the concentration of the sulfide-based solid electrolyte precursor impregnation solution is too low, the sulfide-based precursor is included in the impregnation solution at a low density, and accordingly, the inside of the oxide-based solid electrolyte support may not be filled with a sulfide. On the other hand, if the concentration of the sulfide-based solid electrolyte solution is too high, the viscosity of the sulfide-based solid electrolyte solution increases, and accordingly, the inside of the oxide-based solid electrolyte support may not be filled with the sulfide.

The sulfide-based solid electrolyte precursor used at this time may be represented by Chemical Formula 1 below.

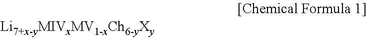

In this case, MIV may be at least one or more elements selected from the group consisting of Si, Ge, and Sn, MV may be at least one or more elements selected from the group consisting of P and Sb, Ch may be at least one or more elements selected from the group consisting of O, S, and Se, X may be at least one or more elements selected from the group consisting of Cl, Br, I, and BH₄, and relationships of 0≤x≤1 and 0≤y≤2 may be satisfied.

Desirably, at least one or more selected from the group consisting of Li₆PS₅Cl, Li₆PS₅Br Li₆PS₅I, Li_{5.5}PS_{4.5}Cl_{1.5}, Li_{5.5}PS_{4.5}Br_{1.5}, Li_{5.75}PS_{4.75}Cl_{1.25}, Li_{6.6}Si_{0.6}Sb_{0.5}S₅I, and Li_{6.6}Ge_{0.6}P_{0.4}S₅I may be included, and more desirably, argyrodite-type Li₆PS₅Cl having a high ionic conductivity at room temperature may be included.

The solvent used in the impregnation solution may be a solvent capable of dissolving the sulfide-based solid electrolyte precursor. For example, it may include at least one or more selected from the group consisting of ethanol, acetonitrile (ACN), and anisole.

Step S34 is a step of removing the solvent remaining in the oxide-based solid electrolyte support that has been immersed into and removed from the sulfide-based solid electrolyte precursor solution, through which the oxide-based solid precursor support may be impregnated with the sulfide-based solid electrolyte.

Specifically, step S34 may be performed at a temperature of 60° C. to 110° C. Desirably, step S34 may include a first drying step and a second drying step. In this case, the first drying step may be performed at 60° C. to 70° C., and the second drying step may be performed at 70° C. to 110° C. The residual solvent may be more reliably removed through the first and second drying steps. If the drying temperature is less than 60° C., the drying time may become longer, and if the drying temperature exceeds 110° C., pores may be formed in the solid electrolyte or the solid electrolyte may be damaged.

Desirably, in step S34, in order to completely evaporate the solvent, the solid electrolyte support may be additionally dried at a temperature of 110° C. to 180° C. for 24 hours.

In the producing method according to an embodiment of the present disclosure, steps S32 and S34 may be repeated two to six times, desirably three to five times, and more desirably four times. At this time, step S30 may include step S36 of further adding the solvent to the sulfide-based solid electrolyte precursor impregnation solution before proceeding with the next steps S32 and S34. For example, when performing the first steps S32 and S34, the concentration of the sulfide-based solid electrolyte precursor impregnation solution may be 0.2 M to 0.35 M, and when performing the last steps S32 and S34, the concentration of the sulfide-based solid electrolyte precursor impregnation solution may be 0.01 M to 0.1 M. However, the concentration of the sulfide-based solid electrolyte precursor solution may gradually decrease as steps S32 and S34 are repeated. When the above method is used, an impregnation force of the sulfide-based solid electrolyte may be improved compared to a case where steps S32 and S34 are performed only once.

In another embodiment of the present disclosure, a composite solid electrolyte produced by the producing method according to an embodiment of the present disclosure may be provided. Specifically, the composite solid electrolyte may be produced by the producing method including: step S10 of producing an oxide-based solid electrolyte membrane by electrospinning a mixture including an oxide-based solid electrolyte precursor and a polymer; step S20 of producing an oxide-based solid electrolyte support by removing the polymer inside the oxide-based solid electrolyte membrane; and step S30 of causing the oxide-based solid electrolyte support to be impregnated with a sulfide-based solid electrolyte using a sulfide-based solid electrolyte precursor impregnation solution including a sulfide-based solid electrolyte precursor and a solvent, wherein step S30 includes step S32 of immersing the oxide-based solid electrolyte support in the sulfide-based solid electrolyte precursor impregnation solution; and step S34 of drying the solvent, steps S32 and S34 are repeated two to six times, and operation 30 further includes step S36 of adding the solvent to the sulfide-based solid electrolyte precursor solution before proceeding with the next steps S32 and S34 when repeating steps S32 and S34.

The oxide-based solid electrolyte support may be produced using the producing method including steps S10 and S20.

Step S10 may be performed in the same manner as described above. A thickness of the oxide-based solid electrolyte membrane produced using the above producing method may be 40 μm and 50 μm. If the thickness of the oxide-based solid electrolyte membrane is less than 40 μm, the oxide-based solid electrolyte membrane may be easily damaged after step S20. On the other hand, if the thickness of the oxide-based solid electrolyte membrane is more than 50 μm, a resistance of the solid electrolyte membrane may increase.

Step S20 may be performed in the same manner as described above. In step S20, the nanofibers in the oxide-based solid electrolyte membrane may be tightly adhered to each other and solidified. Through this, it is possible to produce an oxide-based solid electrolyte support that maintains a predetermined shape without polymers and has excellent mechanical properties. In addition, the ionic conductivity of the solid electrolyte may be improved by removing polymers that cause a decrease in ionic conductivity, and a solid electrolyte that may be used even at a high temperature may be provided.

The produced oxide-based solid electrolyte support may include a LLZO (Li₇La₃Zr₂O₁₂)-based solid electrolyte, which is a garnet-type oxide. At this time, the garnet-type oxide-based solid electrolyte may be of at least one or more types selected from the group consisting of a cubic type and a tetragonal type, and is not limited to including only a specific type. Desirably, it may be a cubic type with a high ionic conductivity.

The oxide-based solid electrolyte produced through these steps is formed of nanofibers and has porous properties.

The composite solid electrolyte may be produced through step S30. As described above, step S30 may include step S32 of causing the oxide-based solid electrolyte support to be impregnated with the sulfide-based solid electrolyte precursor impregnation solution; and step S34 of drying the solvent.

Steps S32 and S34 may be repeated two to six times, desirably three to five times, and more desirably 4 times. At this time, the composite solid electrolyte may be produced by the producing method including step S36 of further adding the solvent to the sulfide-based solid electrolyte precursor impregnation solution before proceeding with the next steps S32 and S34.

The composite solid electrolyte may have smaller pores compared to a composite solid electrolyte that is produced by the composite solid electrolyte producing method except that steps S32 and S34 are performed once. In the composite solid electrolyte produced using the above method, the inside of the support may be densely impregnated with the sulfide-based solid electrolyte, and the pores may have a small size to obtain an improved ionic conductivity, compared to a composite solid electrolyte produced by performing steps S32 and S34 once or a composite solid electrolyte produced by immersing in a sulfide-based solid electrolyte precursor solution having the same concentration several times and drying.

Hereinafter, the present disclosure will be described in more detail with reference to examples, but the present disclosure is not limited to the following examples.

### EXAMPLES

### 1. Production Example: Production of Composite Solid Electrolyte

An oxide-based and sulfide-based composite solid electrolyte was produced by impregnating an oxide-based solid electrolyte support with a sulfide-based solid electrolyte, and specifically, the following producing method was used.

### (1) Step S10: Preparation of Oxide-Based Solid Electrolyte Membrane

The oxide-based solid electrolyte precursor solution (a LLZO precursor solution) was prepared by dissolving LiNO₃, La(NO₃)₃·6H₂O, ZrO(NO₃)₂ xH₂O, and Al(NO₃)₃·9H₂O at a millimole (mmol) ratio of 7.7:3:2:0.25 in a solvent formed of 10 mL of DMF and 2 mL of acetic acid (step S12).

A polymer solution was prepared by dissolving 11% by weight of PVP (M.W. to 1,300,000) with respect to a total weight in 12 mL of an acetic acid solvent (step S14). At this time, a molarity of the polymer solution was 0.0997 mM.

The oxide-based solid electrolyte precursor solution and the polymer solution were mixed at a weight ratio of 58:42 and stirred at a speed of 450 rpm for 3 hours using a stirrer at a temperature of 50° C. to produce a bubble-free mixed solution (step S16).

The mixed solution was electrospun using an electrospinning system. The electrospinning was performed under the conditions of a voltage of 9 kV, an electrospinning solution discharge rate of 0.8 ml/hr, and a electrospinning distance of 12 cm (step S18).

Then, it was dried at 150° C. for 6 hours, and an oxide-based solid electrolyte membrane was produced.

### (2) Step S20: Production of Oxide-Based Solid Electrolyte Support

An oxide-based solid electrolyte support was prepared as follows.

The oxide-based solid electrolyte membrane was calcined by raising the temperature from room temperature to 400° C., which is the calcination temperature, at a temperature increase rate of 1° C./min, and then performing a heat treatment for 2 hours in an air atmosphere.

### (3) Step S30: Production of Composite Solid Electrolyte

A sulfide-based solid electrolyte solution was produced to have a molarity of 0.25 M by dissolving glass LPSCl (Li₆PS₅Cl) in ACN, and the oxide-based solid electrolyte support was immersed in this solution (step S32).

The support extracted from the solution was dried at 60° C. to remove ACN remaining in the support (step S34).

Then, steps S32 and S34 were performed three times in the same manner as described above, except that the solvent, ACN, was further added (step S36), and a solution having a concentration of the sulfide-based solid electrolyte solution which is about 40% lower than a concentration of a solution before adding the solvent was used. At this time, when step S32 was repeated, the concentration of the sulfide-based solid electrolyte solution decreased to 0.16 M, 0.098 M, and 0.057 M, respectively.

Through this, a composite solid electrolyte, in which an argyrodite-type Li₆PS₅Cl solid electrolyte, which is a sulfide-based solid electrolyte, is formed on the oxide-based solid electrolyte support, was finally produced.

### 2. Comparative Example

A solid electrolyte was produced in the same manner as the above production example, except that step S36 was not performed.

### 3. Experimental Example 1: Comparison of Impregnation of Sulfide-Based Solid Electrolyte

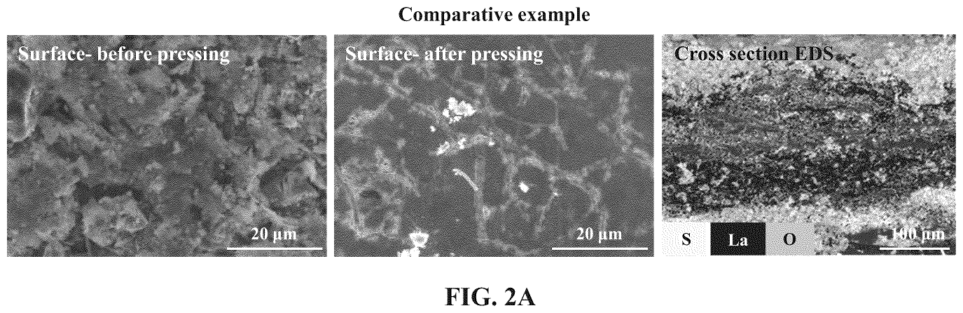

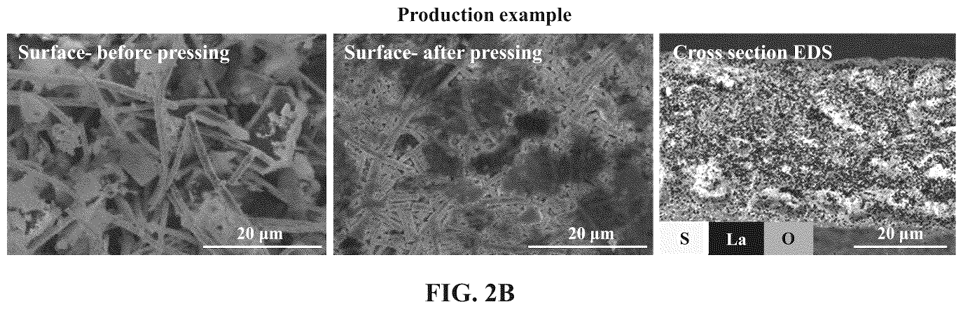

The impregnation of the sulfide-based solid electrolyte in the production example and the comparative example was investigated by scanning electrolyte microscopy (SEM) and energy-dispersive X-ray spectroscopy (EDS), and a result thereof was shown in FIG. 2. In the EDS result, a light blue part indicates sulfur (S), a red part indicates lanthanum (La), and a blue part indicates oxygen (O).

As a result, it was confirmed that, in the production example, smaller pores were observed and sulfur (S) was evenly distributed without being biased, compared to the comparative example, and a thickness (0.8128 mm) in the production example was thinner than a thickness (2.6797 mm) in the comparative example.

Through this, it was confirmed that, in the production example, the inside of the oxide-based solid electrolyte support was evenly impregnated with the sulfide-based solid electrolyte, compared to the comparative example.

### 4. Experimental Example 2: Resistance and Ionic Conduction Characteristics of Composite Solid Electrolyte

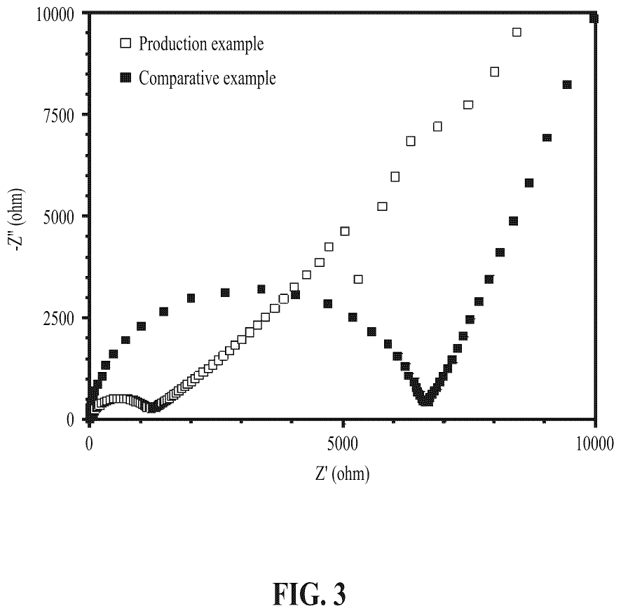

A resistance and ionic conductivity at room temperature of the composite solid electrolytes produced in the production example and the comparative example were investigated. The resistance and the ionic conductivity were measured using electrochemical impedance spectroscopy, and a result thereof was shown in FIG. 3 and Table 1. In FIG. 3, a white part shows a result of the production example and a black part shows a result of the comparative example.

Meanwhile, since the oxide-based solid electrolyte support has a large number of pores, it could not be used alone as a solid electrolyte, and a comparative experiment was not conducted.

TABLE 1

| Classification | Resistance (Ω) | Ionic conductivity (S/cm) |
|---|---|---|
| Production Example | 1214.6 | 0.24 × 10⁻³ |
| Comparative Example | 6328.2 | 1.498 × 10⁻⁵ |

As a result, it was confirmed that, in the production example, the resistance was about 5.21 times lower and the ionic conductivity was improved by about 16 times, compared to the comparative example. From this, it is found that, as the sulfide-based solid electrolyte is more evenly impregnated, the resistance of the composite solid electrolyte may be reduced, and thus the ionic conductivity of the composite solid electrolyte may be significantly improved.

### 5. Experimental Example 3: High Temperature Stability of Composite Solid Electrolyte

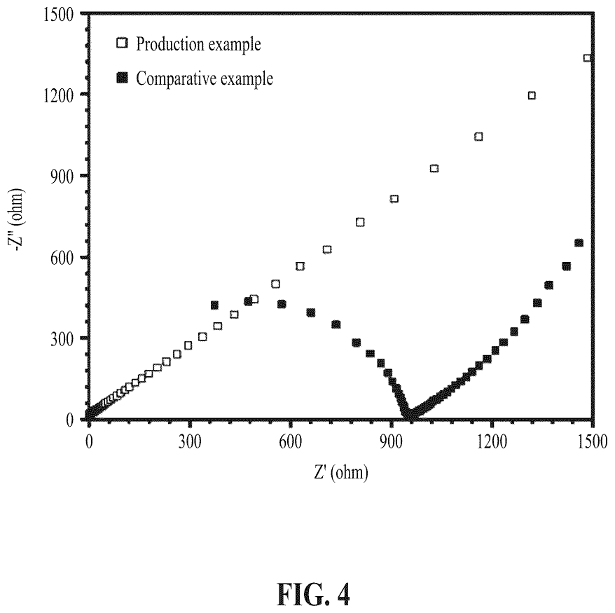

The ionic conductivity at 150° C. of the production example and the comparative example was investigated. The ion conductivity was measured in the same manner as in Experimental Example 2 described above, and a result thereof was shown in FIG. 4 and Table 2. In FIG. 4, a white part shows a result of the production example, and a black part shows a result of the comparative example.

TABLE 2

| Classification | Resistance (Ω) | Ionic conductivity (S/cm) |
|---|---|---|
| Production Example | 18.203 | 15.7 × 10⁻³ |
| Comparative Example | 955.23 | 1.00 × 10⁻³ |

As a result, in the production example, the ionic conductivity was 15 times or more, compared to the comparative example, and the ionic conductivity at 150° C. of the production example was higher than the ionic conductivity at room temperature of the production example. From this, it was confirmed that the composite solid electrolyte of the production example was stable even at a high temperature and may sufficiently perform its role as an electrolyte even when a secondary battery is driven in a high temperature environment.

From the above experimental examples, when the method of producing the composite solid electrolyte described in the scope of the claims of the present disclosure is used, it is possible to improve the impregnation of the sulfide-based solid electrolyte in the oxide-based solid electrolyte, and to produce a large amount of the solid electrolyte having a porous property and a thin film shape of a large area, and the composite solid electrolyte of the scope of the claims of the present disclosure may have excellent mechanical properties and ionic conductivity to enable rapid charging of a secondary battery.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method of producing a composite solid electrolyte, the method comprising:
step S10 of producing an oxide-based solid electrolyte membrane by electrospinning a mixture comprising an oxide-based solid electrolyte precursor and a polymer;
step S20 of producing an oxide-based solid electrolyte support by removing the polymer inside the oxide-based solid electrolyte membrane; and
step S30 of causing the oxide-based solid electrolyte support to be impregnated with a sulfide-based solid electrolyte using a sulfide-based solid electrolyte precursor solution comprising a sulfide-based solid electrolyte precursor and a solvent,
wherein step S30 comprises:
step S32 of immersing the oxide-based solid electrolyte support in a sulfide-based solid electrolyte precursor impregnation solution; and
step S34 of drying the solvent,
wherein steps S32 and S34 are repeated two to six times, and
wherein step S30 further comprises step S36 of adding the solvent to the sulfide-based solid electrolyte precursor solution before proceeding with the next steps S32 and S34 when repeating steps S32 and S34.

2. The method of claim 1, wherein, in step S10, the oxide-based solid electrolyte precursor comprises at least one or more selected from the group consisting of a lithium (Li) precursor, a lanthanum (La) precursor, a zirconium (Zr) precursor, and an aluminum (Al) precursor.

3. The method of claim 1, wherein, in step S10, the polymer comprises at least one or more selected from the group consisting of polyvinyl pyrrolidine (PVP), polyvinyl alcohol (PVA), and polyvinyl acetate (PVAc).

4. The method of claim 1,
wherein, in step S10, a content of the oxide-based solid electrolyte precursor is 57% by weight to 58% by weight with respect to a total weight of the mixture, and
wherein a content of the polymer is 42% by weight to 43% by weight with respect to the total weight of the mixture.

5. The method of claim 1, wherein step S10 comprises:
step S12 of preparing an oxide-based solid electrolyte precursor solution;
step S14 of preparing a polymer solution comprising the polymer,
step S16 of producing the mixture by mixing the oxide-based solid electrolyte precursor solution with the polymer solution; and
step S18 of producing the oxide-based solid electrolyte membrane by electrospinning the mixture.

6. The method of claim 1, wherein, in step S20, the solid electrolyte membrane is heated at 400° C. to 700° C.

7. The method of claim 1, wherein, in step S30, the sulfide-based solid electrolyte precursor solution has a concentration of 0.01 M to 0.35 M.

8. The method of claim 1, wherein, in step S30, the sulfide-based solid electrolyte precursor is represented by Chemical Formula 1 below, 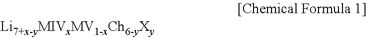
MIV is at least one or more elements selected from the group consisting of Si, Ge, and Sn,
MV is at least one or more elements selected from the group consisting of P and Sb,
Ch is at least one or more elements selected from the group consisting of O, S, and Se,
X is at least one or more elements selected from the group consisting of Cl, Br, I, and BH₄, and
relationships of 0≤x≤1 and 0≤y≤2 are satisfied.

9. The method of claim 1, wherein, in step S30, the solvent comprises at least one or more selected from the group consisting of acetonitrile, ethanol, and anisole.

10. The method of claim 1, wherein, in step S34, the solvent is dried at 60° C. to 110° C.

11. A composite solid electrolyte produced by the method of producing the composite solid electrolyte of claim 1.
